(19) United States
(12) Patent Application Publication
(10) Pub. No.: US 2006/0050092 A1
(43) Pub. Date: Mar. 9, 2006

(54) 2D and 3D display system and method for reformer tube inspection

(76) Inventors: Phillip D. Bondurant, (US); Robin De Lorenzo, (US); Richard Roberts, (US); Tom Cowling, (US)

Correspondence Address: HAYWARD A. VERDUN, LLP, P.O. BOX 698, CENTERVILLE, LA, 70522, US

(21) Appl. No.: 11/180,033

(22) Filed: Jul. 11, 2005

Related U.S. Application Data
(60) Provisional application No. 60/586,498, filed on Jul. 9, 2004.

(51) Int. Cl. G09G 5/00

(52) U.S. Cl. 345/664; 345/665

(57) ABSTRACT

A method for rendering reformer tube inspection data of a reformer tube furnace stack in a colorized 2&3-D graphical format, the method includes analyzing at least a portion of the inspection data, and generating one of a colorized 2D or 3D graphical display depicting inner circumferential diameter of said reformer tube based on the analyzed data, wherein the 2D or 3D graphical display is depicted in spatial orientation to a plurality of reformer tubes comprising the reformer tube furnace.

### CLAIM FOR PRIORITY

This application claims priority under 35 U.S.C. §119 to application No. 60/586,498, filed Jul. 09, 2004, entitled “2D AND 3D DISPLAY SYSTEM AND METHOD FOR REFORMER TUBE INSPECTION,” which is hereby fully incorporated by reference.

### BACKGROUND OF THE INVENTION

1. Field of the Invention

The present invention relates to the displaying of reformer tube data, and more particularly to the graphical display of reformer tube data With fill greater particularity the invention petains to the 2D and 3D graphical display of the inner circumferential diameter in a colorized graphical format.

2. Description of the Related Art

The manufacture of methanol, hydrogen and ammonia utilize a steam reforming process where typically natural gas is combined with steam and then passed through an array of reformer tubes filled with catalyst. This high temperature process (1,600° to 1,800° F.) produces hydrogen that can be converted to methanol or ammonia through subsequent chemical reactions. There can be several hundred reformer tubes in a single steam reformer that is housed within a large furnace. Burners are positioned throughout the furnace to heat the reformer tubes.

Reformer tubes are manufactured by a centrifugal casting process and the cost for a single tube can range from $10,000 to $30,000. The operating life of a reformer tube is approximately 100,000 hours, however the actual lifetime can vary significantly. Blindly replacing tubes at the end of their 100,000 hour lifetime would result in replacing some tubes too soon in addition to the plant suffering numerous and expensive unexpected outages due to some tubes failing prematurely. Replacing tubes well before their predict failure life would unexpected outages, but would be very expensive due to the cost of the tubes and the catalyst that must be replaced. The cost of the catalyst is approximately $5,000 per tube. Catastrophic failure of one tube typically leads to the failure of several adjacent tubes, increasing the cost further.

The lifetime of a specific tube depends on the local environment within the furnace. Poor burner operation, flame impingement or a poor distribution of the flue-gas due to furnace design or refractory tunnel problems can cause significant local temperature variations within the reformer. These furnace problems will expose tubes or portion of tubes to high temperatures which accelerate the failure mechanisms. All of these issues point to the need for some form of a reliable and periodic Non-Destructive Examination (NDE) to maximize the lifetime of each tube while at the same time, minimizing the risk of an unplanned outage due to tube failure.

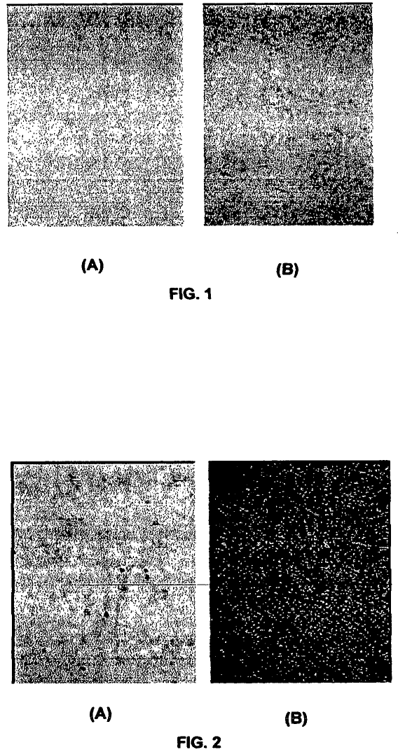

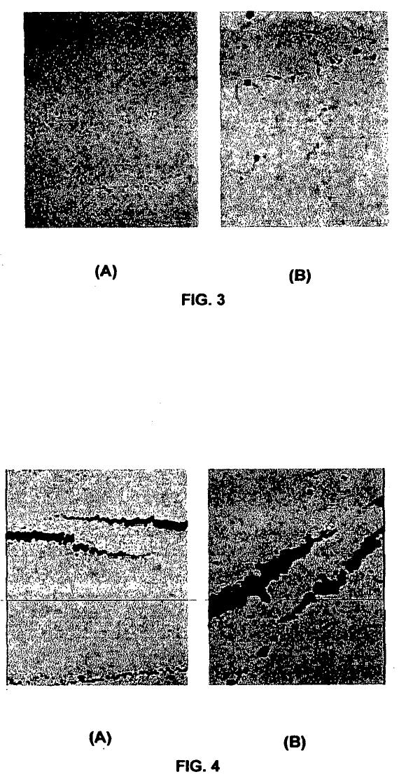

The primary failure mechanism for reformer (or catalyst) tubes is internal cracking that result in bulging and creep growth. The internal cracking is driven by a combination of internal pressure-induced hoop stress and through-wall thermal stresses generated by operational transients. Creep damage first develops within the inner wall of the tube as voids, progressing to coalesced voids and then finally to micro-cracks and macro-cracks. This may evolve into a complete rupture and catastrophic failure of the tube. Bulges are simply creep damage that occurs at specific locations around the circumference of the tube. Detection of creep damage in its first stages by NDE is further complicated due to the coarse structure of the centrifugal cast austenitic tube material and the subtle changes produced by voids. FIG. 1 is a micrograph of undamaged subject material, FIG. 2 is a micrograph showing isolated voids in the material, FIG. 3 depicts subject material with aligned voids and FIG. 4 depicts the subject material after internal cracking has developed.

Conventional NDE Methods

There are numerous methods that are used for inspecting reformer tubes. These are discussed in the following paragraphs:

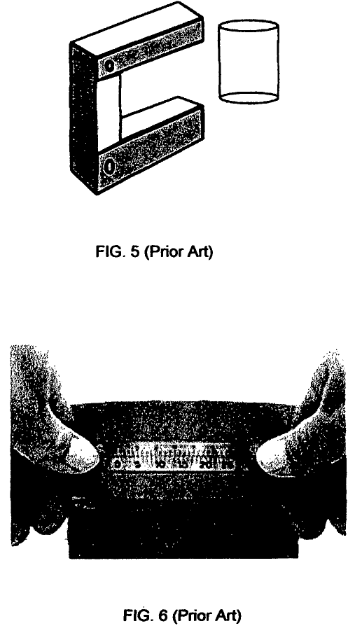

A Go No-Go Gauge, as shown in FIG. 5, is a crude mechanical device that is placed around a reformer tube and manually moved up and down to determine if an outer dimension of the tube exceeds the gauges fixed inner diameter. If the tube exceeds the fixed spacing of the gauge, the gauge will not pass the expanded area and the tube is determined no longer fit for service. The gauge does not provide continuous data along the length of the tube and cannot provide predictive information. In addition, it relies on the operator rotating the gauge around the circumference of the tube to assure there are no bulges.

A Pi-Tape is another crude conventional method, as shown in FIG. 6, wherein a tape-measuring device is placed around a reformer tube to manually measure the outer diameter of the tube. The measuring units on the tape are multiplied by pi so the operator reads the tube diameter directly. This method is very time consuming and unacceptable to use for measuring the entire reformer tube bundle. Also because it is an external measurement method (external to the tube), it would be less accurate due to external oxide shedding. External shedding is a process where the outer layers of the tube flake off during exposure to the high temperature environment. This slowly reduces the outside diameter (OD) of the tube over time.

Eddy Current (ET) is another technique that has been utilized for reformer tube inspection. The technique relies on measuring changes in the electrical impedance of an induction coil placed near the reformer tube caused by changes in the conductivity and permeability of the tube. This method implies the electrical properties of the tube wall change as creep damage occurs. Development of the relationship between the electrical properties of the tube and creep damage must be developed utilizing using tubes with known creep damage. The depth of penetration of eddy currents is primarily influenced by frequency, conductivity, and permeability. The eddy current inspection may occur at multiple frequencies to provide additional insight into the depth of the creep damage. Variations in the lift-off or spacing between the coil and the tube, variations in material permeability, scale formation and chromium migration all have significant influence on the signal response and must be considered by the data analyst before presenting the data.

Measurement of diameter growth from the external surface of the tube is also offered via either a go/no-go gauge as discussed earlier or the measurement of a single diameter. A single diameter measurement across the tube is insufficient to provide a reliable measurement of diameter growth. In addition, the external surface of the reformer tube is a rough surface (not machined) that is subject to shedding. Tube diameter growth measured from the exterior can be partially masked by material shedding that occurs during the life of the tube.

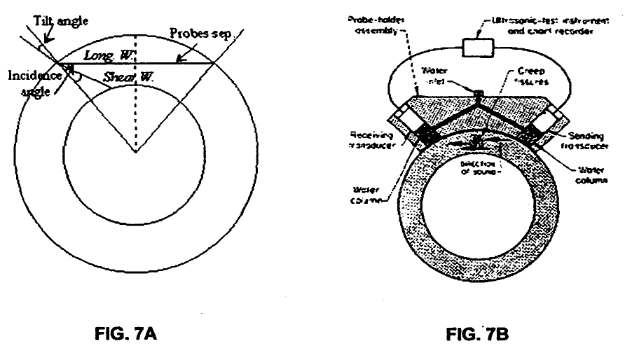

Ultrasonic (UT) methods primarily rely on the analysis of the attenuation and scattering of ultrasonic energy propagated through the wall of the tube. FIG. 7 depicts the geometry of a typical UT based inspection device. Acoustical energy is transmitted from the sending transducer on the right, through the mid-wall of the tube and received by the transducer on the left. Creep damage is detected by developing relationships between the UT signal parameters (such as amplitude, delay, etc) and the material characteristics through extensive testing and field experience. The relationship between UT signal parameters and creep is further complicated by the coarse material structure and the high anisotropy of the centrifugal cast austenitic material that scatters and highly attenuates the UT signals. The other difficulty with this technique is the influence of the tube surface condition that affects the UT signal and gives the impression of creep damage. The tube surface condition can vary from smooth, dimpled, tight scale, to loose scale. A All of the above issues makes quantification of the results difficult, providing only a qualitative assessment and subject to operator judgment As a result it is very difficult, if not impossible, to provide a continuous measurement of the level of creep damage over the full length of the tube that is automatically and reliably produced using this method.

It is also important to note that a full 360-degree inspection of the tube is not typically performed. There is usually only two transducer transmitter/receive pairs on each side of the tube leaving portions of the tube un-inspected. To address inspection reliability, some companies have implemented a combination of the UT, eddy current and single diameter measurements (OD) onto a single inspection tool. This decreases the reliability of the equipment and provides even more information for the operator and data analyst to manually interpret and present to the plant operators.

Replication is another method utilized for in-situ assessment of reformer tubes to detect overheating that causes micro-structural changes. Replication is an isolated “spot” type assessment performed on the outer surface of the tube and is normally used as a supplemental technique. Only the advanced stages of creep damage can be assessed utilizing in-situ replication. Again, this method is not suitable to provide a continuous assessment over the full reformer tube array and cannot provide and early enough indicator or measurement of creep damage to be useful for overall reformer assessment.

Random radiographic inspection is another method utilized as a supplementary technique to confirm the presence of severe cases of creep damage. It is reasonable to expect to locate such damage when it has extended 50% in the thru-wall direction, when the tubes are filled with catalyst and isotopes are used instead of an X-ray tube. Although using an X-ray tube provides an improved quality image, it is not normally employed, because of practical conditions on site. Again, this method is not suitable overall reformer assessment

LOTIS™ NDE Method

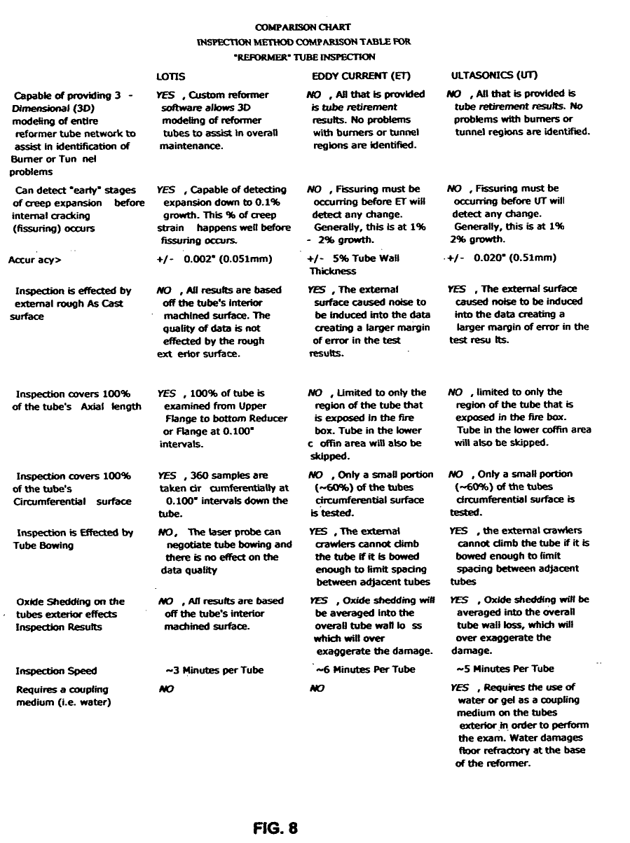

A recent study performed by Methanex, the world's largest methanol manufacturers, was able to compare the different inspection techniques based upon historical data and field inspection comparison. This study determined that Laser Profilometry (LP) of the internal machined surface of the reformer tube was the only technique capable of identifying creep strain in its earliest stages (see FIG. 8 which is a chart that compares the various systems currently utilized by the industry and their pros and cons). High accuracy internal surface mapping is the most reliable method of measuring creep strain as a direct result of diametrical expansion (with accuracies of ±0.05%) of the tube's inner surface.

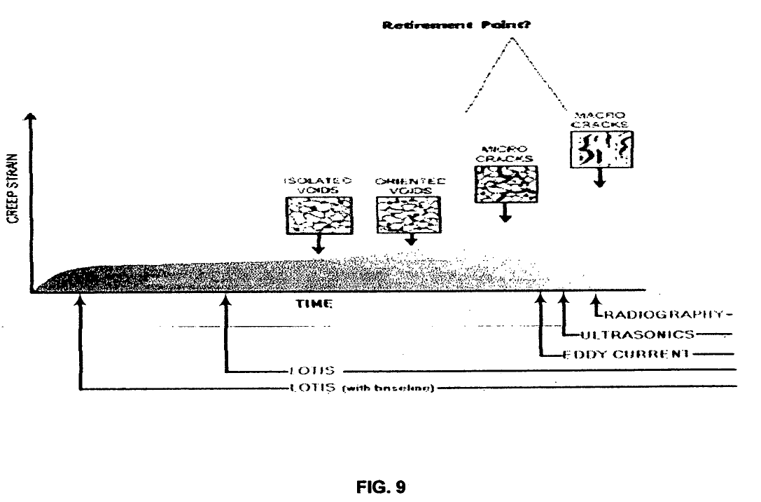

Other techniques, such as eddy current or ultrasonic as discussed above, are only able to identify creep damage after micro-cracking has reached sufficient severity. Many plant operators consider these last two stages as the retirement point of a reformer tube. FIG. 9 depicts an overview of the life cycle of a reformer tube and identifies at what points in the life cycle that each NDE technique is capable of identifying creep damage.

The traditional eddy current and ultrasonic inspection methods do not provide a continuous measurement that can be automatically interpreted. As discussed previously, the raw inspection data must be interpreted by an operator and flaws identified manually. This process is time consuming and the data is typically presented in a tabular format, as a single tube with the flaws manually identified on the tube, or a two dimensional (2D) array of tubes showing which tubes in the reformer that have problems. Continuous measurement of diameter over at least a portion of or the full axial length of the reformer tube, as in the present invention, allows automatic data analysis and a true three-dimensional (3D) data presentation

The axial and circumferential data density must be sufficient such that the true average diameter at each axial position can be calculated and bulges can be detected. Display of these data in a 3D format matching the physical structure of the reformer clearly shows the relationships between adjacent, or a portion of adjacent tubes, and provides a powerful diagnostic tool that not only unambiguously automatically identifies problematic tubes, but allows the plant personnel to clearly visualize the problem areas and take action to replace tubes, accurately predict lifetimes and rebalance the heat distribution to reduce damage in the future. This is a capability long desired by plant operators but here-to-fore not available to them.

The present invention uses LOTIS™ (Laser Optic Tube Inspection System) Laser Profilometry (LP) technology to generate the continuous radius/diameter data necessary to provide the 3D visualization method that is the subject of this patent However it is understood that other methods of generating the accurate and continuous dimensional data have been contemplated. These methods would include a minimum of 2 diameter measurements (or 4 radii) and could be either contact or non-contact methods for measurement of the ID. A more complete description of the LOTIS laser profilometry tool and it application to reformer tube inspection is provided in U.S. Patent applications: Ser. Nos. 10/713,415, 10/707,629 and 10/707,630. These are included as part of this application by reference.

Laser Profilometry is a non-contact, non-destructive inspection technique utilizing laser-based optical triangulation as the basic sensing method. In this particular case it is being used to profile the internal radius of reformer tubes. The LOTIS laser probes include a rotating head, which spins at approximately 1,800 rpm and acquires 360 radius readings per revolution along the internal surface of a tube and has a helical path as small as 0.01 inches. A range of probe sizes can accommodate different tube diameters. A person skilled in the art will appreciate that the rotating speeds or the number of samples per revolution can be increased or decreased without changing the ability to provide accurate and continuous diameter or bulging information from the reformer tubes.

Prior Art Data Display Methods

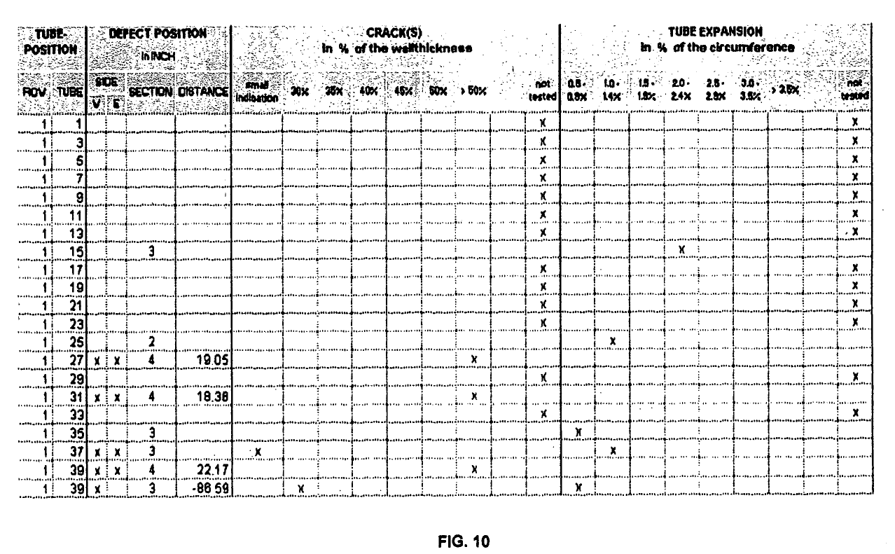

FIG. 10 is a sample of reformer data presented in a tabular format that shows tube position within the reformer (row and tube number), the defect height, which section of the tube the flaw is in, crack size in percentage of wall thickness and tube expansion along one axis in % of circumference. Note that tube expansion is a single diameter reading and that the crack readings are only taken on the east or west side of the tube, not all the way around. This is not continuous data.

FIG. 11 is the data from FIG. 10 in a two-dimensional display format that shows two rows of reformer tubes indicating the worst case cracks detected in each tube. It is important to note there is nothing on the graph that indicates the axial height of the flaw. The lack of a third dimension in the display, and indicating only the worst-case flaw per tube precludes a fill and rapid analysis of the data set. This method does not consider that the method for determining creep stain by looking at cracking is flawed to begin with.

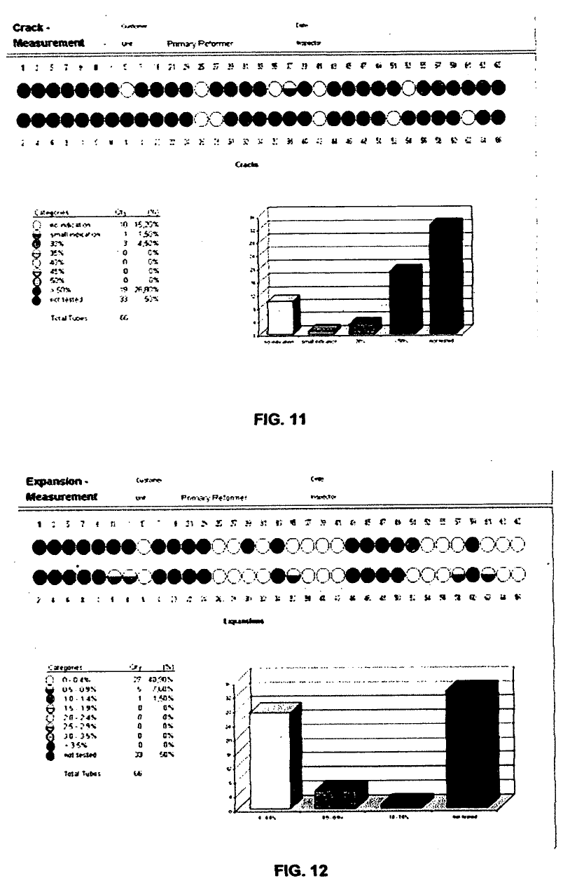

FIG. 12 is the data from FIG. 10 in a two dimensional display format that shows two rows of reformer tube indicating the worst-case expansion (along one axis) in each tube. Again, as in FIG. 11, there is nothing to indicate the axial height of the flaw. The lack of a third dimension in the display, and indicating only the worst-case expansion per tube precludes a fill analysis and subsequent exploitation of the relationships between adjacent tubes.

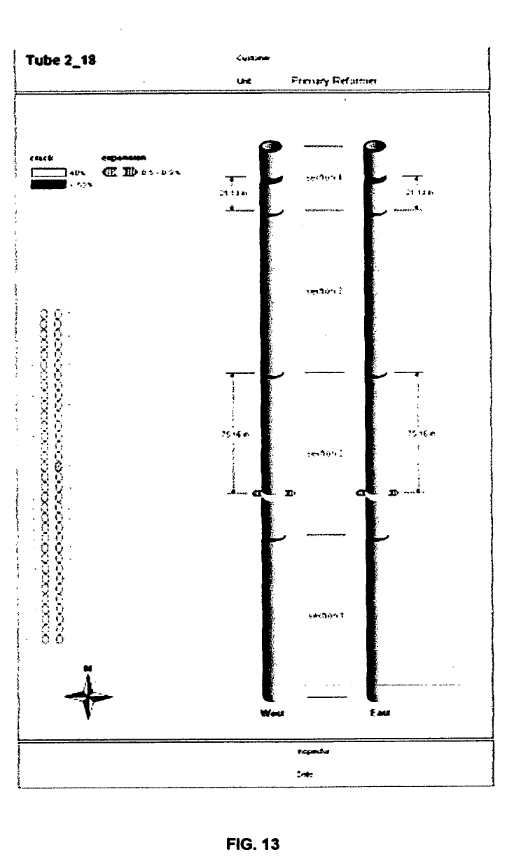

FIG. 13 is the data from FIG. 10 for a single tube. Although appearing to be a 3-D representation of the tube, it is not. FIG. 13 is merely two sides of a tube (east and west) with the flaws identified at their proper height within the tube. Again, there is no way of visualizing the adjacent tubes and their relative locations within the reformer providing the end user with a comprehensive view of what is occurring at a specific location in the reformer. There is no information in this display that is useful in modifying the reformer operation to control hot or cold spots or determining if this problem was due to a manufacturing defect or is a problem with heat distribution within the reformer.

### SUMMARY OF THE INVENTION

An aspect of the present invention can be characterized as a method for rendering reformer inspection data in a colorized 2&3-D graphical format, the method includes acquiring inspection data, analyzing at least a portion of the inspection data, and generating a colorized graphical display of analyzed data representing at least a portion of reformer tube configuration and the display is capable of being rotated from 0 to 360 degrees in any of the X, y and Z dimensions.

### DETAIL DESCRIPTION OF THE INVENTION

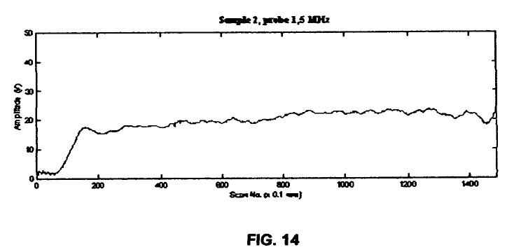

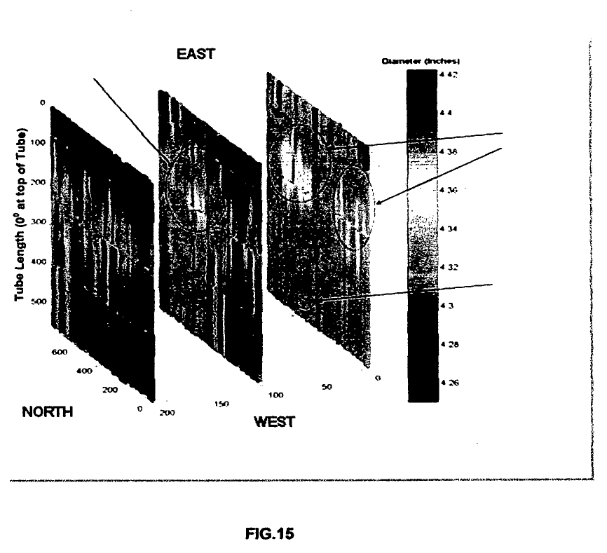

FIG. 14 is a 3-D colorized display of the present invention. This display is a 3D representation of diameter growth for the entire reformer tube network, although portions can be displayed along the x, y and z planes corresponding to one or more points of interest The color bar on the side indicates the percent of diameter creep growth. There are 10 rows of tubes displayed in FIG. 14, with a plurality of 68 tubes in each row. The axial location of the data is shown on the vertical axis. FIG. 14, i.e. the reformer stack, can be viewed from any orientation and zoom. The reader should note the clear indication of problem area (creep stain) in the lower portion of the reformer bundle on the “B” side.

FIG. 15 is a similar display to FIG. 14, but displays only 3 rows of tubes, which makes it easier to visualize creep growth in the center of the reformer tube bundle. In this case the diameters of the tubes are displayed instead of the percent creep growth. It is very easy to see relationships between the tubes as well the four different jointed sections for each tube. Each tube is formed at the factory by welding four tube sections together. This high-resolution display is very useful in discovering manufacturing problems.

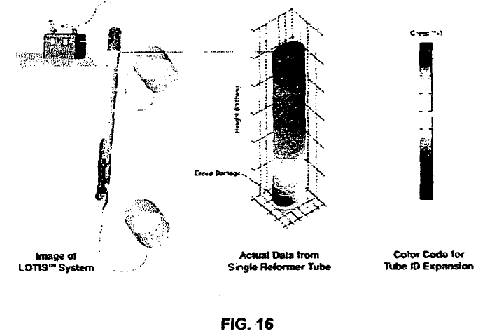

FIG. 16 is a 3D display of a single reformer tube with an adjacent pictorial that show how the LOTIS measurement probe is pulled through the reformer tube. In this graphic one can detect bulges and other asymmetries associated with the geometry of the tube.

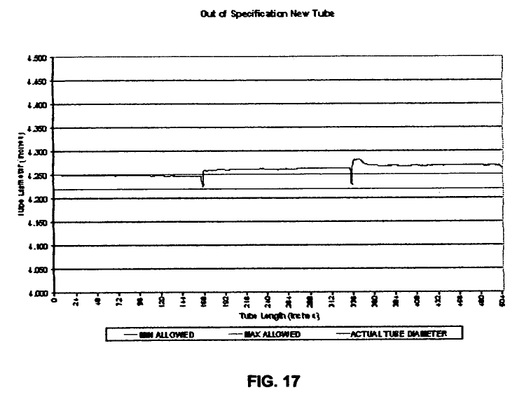

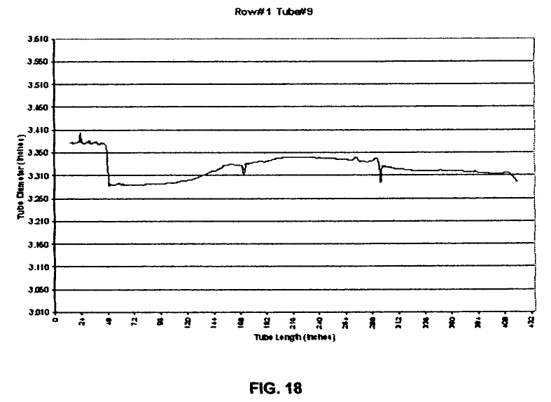

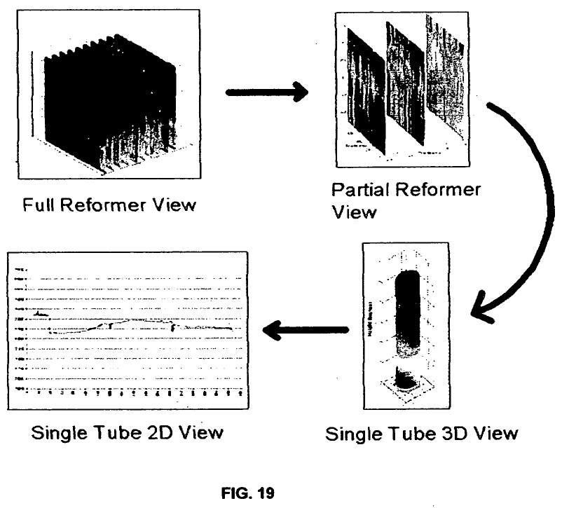

Each of the color images (FIGS. 14 through 16) can be rotated 360° in every direction in order to allow complete visualization of the tube and the entire reformer tube network. This ability helps identify areas where bulging or flame impingement may be present. 3-D modeling of the reformer as a whole provides plant operators with key elements for decision-making regarding the operation of the reformer furnace. Portions of the reformer tube network can also be plotted if a particular region of the reformer is of interest. Quantitative line graphs for each tube can also be plotted in 2D providing such information as average diameter, ovality, differences between two different inspections, etc. FIG. 17 provides an x-y plot of the average diameter as a function of the distance into the tube. This particular tube is new and clearly out of specification as demonstrated by the continuous diameter data falling outside the upper and lower specification limits indicated by the two horizontal lines. FIG. 18 is a tube that shows creep damage as illustrated by the variation in average diameter over the length of tube.

The most accurate assessment of the reformer tubes can be completed if a baseline examination is performed before the tubes go into service. First, baseline inspections reveal any manufacturing flaws that may be present in the interior surface of the tube such as, over boring and excessive root penetration. Over boring of tubes can result in reduced tube life expectancy; an over bore of 0.030″ from the tube specification can result in a decreased tube life of nine to fourteen months. Any defects such as excessive root weld penetration and internal step changes in boring present in the tube interior surface can act as stress risers and lead to premature tube failures. Identification of these flaws at the tube mill can enable these defects to be corrected before delivery of the tube to site. Baseline inspections also allow more precise and accurate internal diameter readings of the new reformer tubes before they are exposed to operating conditions. This information can then be utilized to monitor the effect of creep strain at an even earlier stage because the as-built dimension of the tube within the manufacturing tolerance band is known.

In service examination of reformer tubes can be performed without having previously done a base line exam. As discussed earlier, in-service exams will not only identify tubes that need to be removed from service due to creep strain but will also assist the plant owner to identify lack of uniformity in the reformer balance due to: flue-gas misdistribution due to furnace design or refractory tunnel problems; flame impingement; and poor burner operation. It is also important to emphasize that because LOTIS laser profilometry equipment scans the entire inside length of the tube, diameter data is available in portions of the tube that have not been exposed to harsh furnace environment that can serve as an alternative base line. This base line segment helps improve the accuracy of the creep strain measurement, particularly when baseline inspections of the tube when it was new were not completed.

As with any technology, Laser Profilometry also has a few limitations; the most obvious of these being that the laser is not capable of inspecting the exterior surface of the tube from the inside. This limits the inspection frequency to the frequency of catalyst change-outs since access to the inside bore of the tubes is required in order to insert the probe. However, the 3D visualization approach described in the present invention can also be used to display exterior diameter data to provide an estimate of creep growth between catalyst change-outs. Although less accurate, a device that crawls on the outside of the tube that continuously measure multiple diameters along the length of the tube can be used and the data visualized using this invention. The data will require correction for the estimated amount of exterior oxide shedding.

Besides the 3D visualization of absolute creep growth, the present invention can also display changes in diameter between inspections to determine the rate of change of creep between inspections.

The present invention provides a holistic approach to reformer information display that has hereto-fore been unavailable to the industry, as well as providing additional analytical tools by virtue of the display methodology long sought by plant operators. FIG. 18 provides a summary cartoon of the various displays utilized under this invention. It includes a full reformer network display, the ability to zoom and pan within the reformer network to display portions of the network from all angles, the ability to display a 3D view of a single tube that can pan, zoom and rotate, and 2D x-y graphs that provide specific information as a function of position along individual tubes. The 2D x-y graphs can also display information from several tubes at a time for comparison purposes.

Additional aspects of the present invention, as will be appreciated by those skilled in the art, is the capability to analyzed data collected by other techniques. Furthermore, the present invention can analyze all or a portion of the data collected from any source and provides a 3-D rendering of the data in a colorized graphical format that provides the user with information and analysis of legacy data.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed:

1. A method for rendering reformer tube inspection data comprising a reformer tube furnace in a colorized 2&3-D graphical format, the method comprising:
analyzing at least a portion of the inspection data; and
generating one of a colorized 2D or 3D graphical display depicting inner circumferential diameter of said reformer tube based on the analyzed data, wherein the 2D or 3D graphical display is depicted in spatial orientation to a plurality of reformer tubes comprising the reformer tube furnace.

2. The graphical display method of claim 1, wherein the colorized graphical display of the at least a portion of the reformer tube configuration is displayed in physical orientation with at least a portion of adjacent reformer tubes.

3. The graphical display method of claim 1, wherein the graphical display of a least a portion of the reformer tube is capable of being rotated from 0 to 360 degrees in any of an X, Y and Z dimensions.

4. The graphical display method of claim 1, wherein data is analyzed for at least a portion of a plurality of reformer tubes.

5. The graphical display method of claim 4, wherein data analyzed is capable of being rotated from 0 to 360 degrees in any of an X, Y and Z dimensions.
